(19) United States
(12) Patent Application Publication
(10) Pub. No.: US 2006/0059302 A1
(43) Pub. Date: Mar. 16, 2006

(54) Disk array subsystem

(76) Inventor: Susumu Tsuruta, Odawara (JP)

Correspondence Address: REED SMITH LLP, Suite 1400, 3110 Fairview Park Drive, Falls Church, VA, 22042, US

(21) Appl. No.: 10/983,583

(22) Filed: Nov. 9, 2004

(30) Foreign Application Priority Data
Sep. 14, 2004 (JP) 2004-266246

(51) Int. Cl. G06F 13/00

(52) U.S. Cl. 711/113; 711/114

(57) ABSTRACT

There is a technique for a disk array subsystem which can reduce the number of LSIs required per one channel and mount more channels on a package, in a package of a channel control unit. In the disk array subsystem, a channel control unit receiving a data input/output request from an external unit has: a plurality of link control LSIs establishing communication with the external unit; a plurality of processors (MP) processing the data input/output command from the external unit; and a channel control LSI having a bridge control unit for changing a plurality of buses respectively connected to the link control LSIs and processors, connecting the bus connected to the link control LSI and the bus connected to the processor by the bridge control unit, and transferring the data between the link control LSI and the cache memory in accordance with the processor.

### CROSS-REFERENCE TO RELATED APPLICATION

The present application claims priority from Japanese patent application No. JP 2004-266246 filed on Sep. 14, 2004, the content of which is hereby incorporated by reference into this application.

### BACKGROUND OF THE INVENTION

The present invention relates to a technique of a disk array subsystem and more particularly to a technique effectively applied to a structure of a channel control unit receiving a data input/output request from an external unit.

In accordance with a study of the inventor of the present invention, the following technique can be considered in connection with a technique of a conventional disk array subsystem.

For example, the disk array subsystem is composed of: a plurality of storage volumes for storing data; a disk control unit for controlling data input/output to the storage volumes; a channel control unit for receiving a data input/output request from an external unit; a shared memory in which control information communicated by the channel control unit and the disk control unit is stored; a cache memory in which the date communicated between the channel control unit and the disk control unit is temporarily stored; an internal connection unit connected to them; a management terminal for managing its own disk array subsystem; and the like.

In this disk array subsystem, at least one or more logical volume is set on a physical memory region provided by a storage volume group, and the logical volume is provided to an external host computer. The host computer writes and reads data with respect to the logical volume, by sending a predetermined command.

In a computer system including a storage unit such as the above-mentioned disk array subsystem, there is a technique for using the data on various storage units in common between the host computers having various host computer input/output interfaces (for example, Patent Document 1 (Japanese Patent Laid-open No. 9-325905)).

### SUMMARY OF THE INVENTION

However, as a result obtained from what the inventor has examined about the technique of the conventional disk array subsystem, the followings have become apparent.

For example, in the disk array subsystem, a package of the channel control unit is constituted by link control for establishing communication with the host computer and channel control for transferring data between the link control and the cache memory, and bus bridges for changing a plurality of buses each connected to the link control and a processor are constituted by respective independent LSIs. Accordingly, in order to increase the number of channels and increase degree of freedom of a system structure, it is necessary to arrange a plurality of LSIs and a plurality of buses on a package, so that an area of arrangement, a bus speed and the like cause problems.

Accordingly, an object of the present invention is to provide a technique of a disk array subsystem which can reduce the number of LSIs required per channel and mount more channels on the package, in the package of the channel control unit.

The above and other objects and novel features of the present invention will become apparent from the description of the specification and the accompanying drawings.

Outlines of representative ones of inventions disclosed in the present application will be briefly described as follows.

The present invention is applied to a disk array subsystem comprising: a plurality of storage volumes storing data; a disk control unit controlling data input and output with respect to the plurality of storage volumes; a channel control unit receiving a data input/output request from an external unit; a shared memory storing control information communicated by the channel control unit and the disk control unit; a cache memory temporarily storing date communicated between the channel control unit and the disk control unit; an internal connection unit connected to the channel control unit, the disk control unit, the shared memory, and the cache memory; and a management terminal connected to the channel control unit, the disk control unit, and the shared memory and managing its own disk array subsystem, and has the following features.

(1) In the present invention, the channel control unit includes: a plurality of link control LSIs establishing communication with the external unit; a plurality of processors processing the data input/output command from the external unit; and a channel control LSI having a bus bridge control means for changing a plurality of buses respectively connected to the plurality of link control LSIs and the plurality of processors, connecting the bus connected to the link control LSI and the bus connected to the processor by the bus bridge control means, and transferring the data between the link control LSI and the cache memory in accordance with an instruction of the processor.

Also, the bus bridge control means of the channel control LSI changes a plurality of buses to a plurality of other buses or vice versa, and connects each of the buses connected to the plurality of link control LSIs and each of the buses connected to the plurality of processors. Further, the bus bridge control means has an address storing means for storing a connection-destination address, whereby a connection destination is changed based on an address stored in the address storing means.

Also, the bus bridge control means of said channel control LSI has a monitoring function of monitoring a bus state of a connection destination, whereby, as a result of monitoring by the monitoring function, a bridge operation is swept if the bus of the connection destination is failure and the bridge operation is executed if the bus of the connection destination is normal. Further, the channel control LSI has a bus state storing means for storing a state of each of the buses, and the monitoring function monitors the state of each of the buses by referring to the bus state storing means. Additionally, the channel control LSI sends an error signal to another bus bridge control means at a time when its own bus bride control means detects failure of its own bus, and sets failure information of the its own bus to the bus state storing means of the another bus bridge control means.

Also, the bus bridge control means of the channel control LSI has a double write function, makes two processors respectively connected to second and third buses establish communication with the input/output command issued by the link control LSI connected to a first bus, and makes a processing request to a quickly responding processor among the processors receiving and capable of processing the input/output command.

(2) In the present invention, another channel control unit includes: a plurality of link control LSIs establishing communication with the external unit; a plurality of processors processing the data input/output command from the external unit; a plurality of channel control LSIs each having a bus bridge control means for changing a plurality of buses respectively connected to the plurality of link control LSIs and the plurality of processors, connecting the bus connected to the link control LSI and the bus connected to the processor by the bus bridge control means, and transferring the data between the link control LSI and the cache memory in accordance with an instruction of the processor; and a storage means each provided on the buses connected between the plurality of channel control LSIs and storing connectability information of a path.

Also, the link control LSI is accessible to the storage means, and refers to the storage means to determine path connectability. Further, the storage means is accessible from the management terminal, and the connectability information of the path is set from the management terminal. Additionally, the link control LSI records connection state information of the path in the storage means, and the management terminal can refer to a connection state of the path.

Also, the bus bridge control means of the channel control LSI changes a plurality of buses to a plurality of other buses or vice versa, and connects each of the buses connected to the plurality of link control LSIs and each of the buses connected to the plurality of processors. Further, the bus bridge control means has an address storing means for storing a connection-destination address, whereby a connection destination is changed based on an address stored in the address storing means.

Also, the bus bridge control means of the channel control LSI has a monitoring function of monitoring a bus state of a connection destination, whereby, as a result of monitoring by the monitoring function, a bridge operation is swept if the bus of the connection destination is failure and the bridge operation is executed if the bus of the connection destination is normal. Further, the channel control LSI has a bus state storing means for storing a state of each of the buses, and the monitoring function monitors the state of each of the buses by referring to the bus state storing means. Further, the channel control LSI sends an error signal to another bus bridge control means at a time when its own bus bride control means detects failure of its own bus, and sets a failure information of the its own bus to the bus state storing means of the another bus bridge control means.

Also, the bus bridge control means of the channel control LSI has a double write function, makes two processors respectively connected to second and third buses establish communication with the input/output command issued by the link control LSI connected to a first bus, and makes a processing request to a quickly responding processor among the processors receiving and capable of processing the input/output command.

Effects obtained from representative ones of inventions disclosed in the present application will be briefly described as follows.

(1) Since the number of LSIs required per one channel is reduced by installing the bus bridge control means into the channel control LSI, it is possible to mount more channels on the package.

(2) Since it is possible to access between the processor on a certain bus and the link control LSI on the other bus, by making it possible to bridge a plurality of sets of bus bridge control means by a plurality of bus bridge control means, the degree of freedom of the operation of each channel is increased and the control such as load sharing can be executed.

(3) Since the bus bridge control means can monitor the bus state of the connection destination, it is possible to continue the other bridge operations without being affected by the failure etc. of the bridge destination.

(4) Since the write command issued by the link control LSI establishes communication with two processors by providing the double write function to the bus bridge control means, it is possible to selectively determine the processor which is made to process the host command by the link control LSI on the basis of less number of communications.

(5) Since the storage means for storing the connectability information of the path is connected between the plurality of channel control LSIs, the link control LSI refers to the storage means to determine whether the logical path is established, so that it is possible to lower the load of the processor. In particular, it is possible to prevent a processing capacity of the disk array subsystem from being down, with respect to an unfair logical path establishment request.

### BRIEF DESCRIPTIONS OF THE DRAWINGS

FIG. 1 is a block diagram showing the entire configuration of a system including a storage system according to an embodiment of the present invention.

FIG. 2 is a block diagram showing a configuration of a channel control unit in a storage system according to an embodiment of the present invention.

FIG. 3 is a block diagram showing a configuration of a conventional channel control unit as a comparative embodiment of FIG. 2.

FIG. 4 is a flow chart showing an operation of a channel control unit in a storage system according to an embodiment of the present invention.

FIG. 5 is a block diagram showing a configuration of a channel control LSI in a storage system according to an embodiment of the present invention.

FIG. 6 is a block diagram showing a configuration of a bridge control unit in a storage system according to an embodiment of the present invention.

FIG. 7 is an explanatory diagram for showing connection signals between bridge control units in a storage system according to an embodiment of the present invention.

FIG. 8 is a flow chart showing a write bridge operation in a storage system according to an embodiment of the present invention.

FIG. 9 is a flow chart showing a read bridge operation in a storage system according to an embodiment of the present invention.

FIG. 10 is a flow chart showing a write bridge operation (bus (3) failure case (1)) in a storage system according to an embodiment of the present invention.

FIG. 11 is a flow chart showing a write bridge operation (bus (3) failure case (2)) in a storage system according to an embodiment of the present invention.

FIG. 12 is a flow chart showing a read bridge operation (bus (3) failure case (1)) in a storage system according to an embodiment of the present invention.

FIG. 13 is a flow chart showing a read bridge operation (bus (3) failure case (2)) in a storage system according to an embodiment of the present invention.

FIG. 14 is an explanatory diagram for showing a bridge path at a time of bus (3) failure in a storage system according to an embodiment of the present invention.

FIG. 15 is an explanatory diagram for showing a bridged space MAP of a bus (3) in a storage system according to an embodiment of the present invention.

FIG. 16 is a flow chart showing a double write bridge operation in a storage system according to an embodiment of the present invention.

FIG. 17 is a flow chart showing a command-processing request method using a double write in a storage system according to an embodiment of the present invention.

FIG. 18 is a block diagram showing a configuration of other channel control unit in a storage system according to an embodiment of the present invention.

FIG. 19 is an explanatory diagram for showing a configuration of a path management information memory in a storage system according to an embodiment of the present invention.

FIG. 20 is a flow chart showing a path establishing procedure in a storage system according to an embodiment of the present invention.

### DESCRIPTION OF THE PREFERRED EMBODIMENTS

Hereinafter, an embodiment of the present invention will be detailed based on the drawings. Note that members having the same function are denoted in principle by the same reference numeral throughout all the drawings for describing the embodiment and the repetitive description thereof will be omitted.

<Concept of Invention>

A storage system (a disk array subsystem) of the present invention is composed of a storage volume, a disk control unit, a channel control unit, a shared memory, a cache memory, an internal connection unit, and a management terminal, etc. The storage volume stores data. The disk control unit controls a data input and output to the storage volume. The channel control unit receives a data input/output request from an external unit. The shared memory stores control information communicated by the channel control unit and the disk control unit. The cache memory temporarily stores data communicated between the channel control unit and the disk control unit. The internal connection unit is connected to the channel control unit, the disk control unit, the shared memory and the cache memory. The management terminal is connected to the channel control unit, the disk control unit, and the shared memory, and manages its own disk array subsystem.

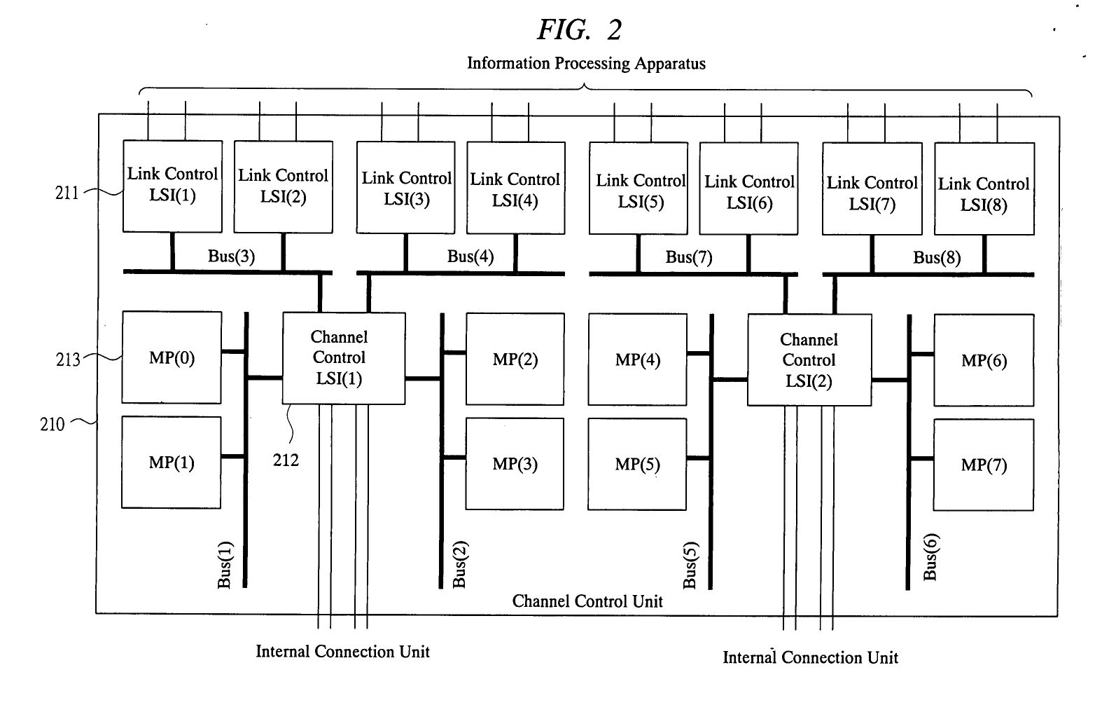

In the configuration mentioned above, in particular, the channel control unit has a configure that includes: a plurality of link control LSIs each establishing communication with the external unit; a plurality of processors processing a data input/output command from the external unit; and a channel control LSI having a bridge control unit (bus bridge control means) for changing a plurality of buses respectively connected to a plurality of link control LSIs and a plurality of processors, connecting the bus connected to the link control LSI and the bus connected to the processor by the bridge control unit, and transferring the data between the link control LSI and the cache memory on the basis of instructions of the processor. A description will be in detail made below with reference to FIGS. 2 to 17.

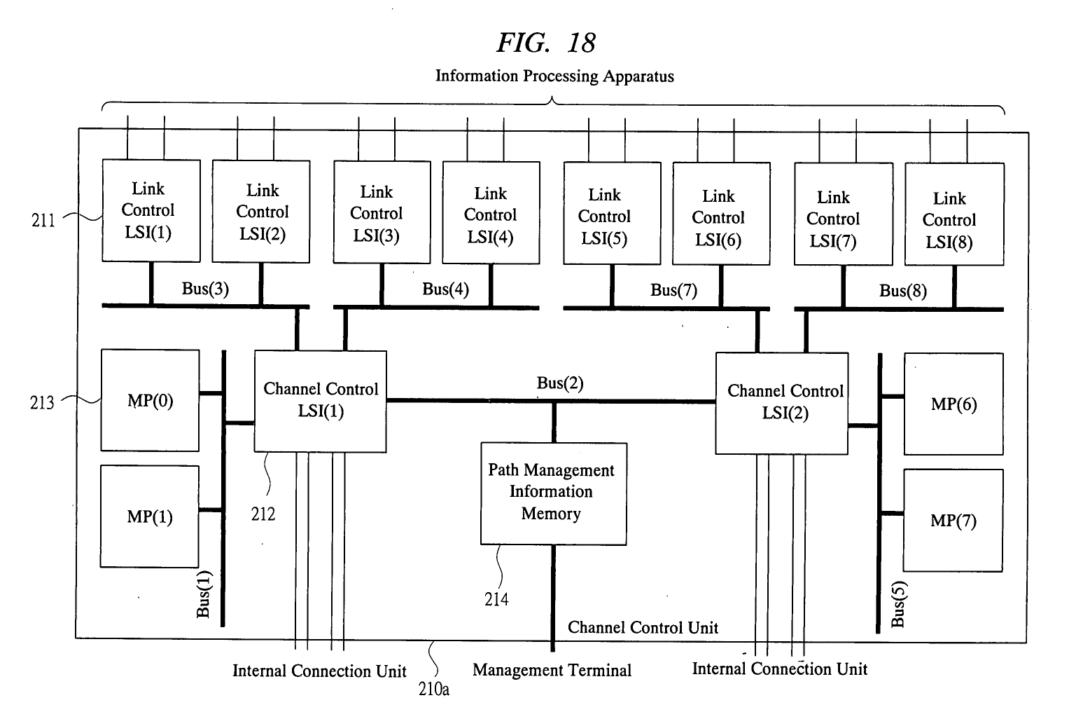

Further, the other channel control unit has a configuration that includes: a plurality of link control LSIs establishing communication with the external unit; a plurality of processors each processing a data input/output command from the external unit; a channel control LSI having a bridge control unit (bus bridge control means) for changing a plurality of buses respectively connected to a plurality of link control LSIs and a plurality of processors, connecting a bus connected to the link control LSI and a bus connected to the processor by the bridge control unit, and transferring data between the link control LSI and the cache memory on the basis of an instruction of the processor; and a path management information memory (storage means) that is provided on the bus connected between the plurality of channel control LSIs and stores connectability information of a path. A description will be in detail made below with reference to FIGS. 18 to 20.

<Entire Configuration of System including Storage System>

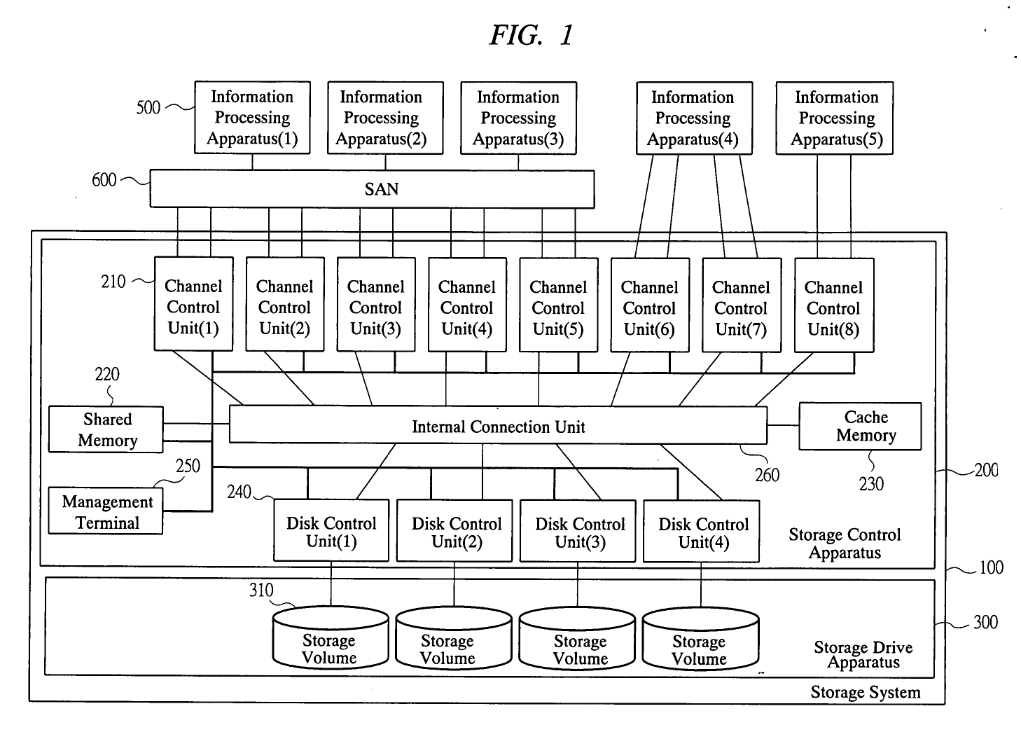

A description will be made of an example of the entire configuration of a system including a storage system according to an embodiment of the present invention with reference to FIG. 1. FIG. 1 is a block diagram showing the entire configuration of a system including the storage system.

A system including a storage system according to the present embodiment is configured by a storage system 100 and information processing apparatuses (1) to (5) 500 which are upper apparatuses, as shown in FIG. 1.

The storage system 100 is provided with a storage control apparatus 200 and a storage drive apparatus 300. The storage control apparatus 200 executes control to the storage drive apparatus 300 in accordance with a command, for example, received from the information processing apparatus 500. For example, the storage control apparatus 200 receives a data input/output request from the information processing apparatus 500, and reads and writes data with respect to each storage volume 310 provided in the storage drive apparatus 300.

The information processing apparatus 500 is an information device such as a computer provided with a central processing unit (CPU) and a memory. Various programs are executed by the CPU provided in the information processing apparatus 500, whereby various functions are achieved. The information processing apparatus 500 may be constituted by, for example, a personal computer or work station, or may be constituted by a main frame computer. In particular, the information processing apparatus 500 is utilized, for example, as a central computer in an automatic deposit teller system of a bank, a seat reservation system of an aircraft, and the like.

In FIG. 1, the information processing apparatuses (1) to (3) 500 are communicably connected to the storage control apparatus 200 via a storage area network (SAN) 600. The SAN 600 is a network for executing the data input/output request and the data transmission and reception between the storage drive apparatus 300 and the information processing apparatuses (1) to (3) 500. The communication between the information processing apparatuses (1) to (3) 500 and the storage control apparatus 200 established via the SAN 600 can be executed, for example, in accordance with a fiber channel protocol.

Further, the information processing apparatuses (4) and (5) 500 are communicably connected directly to the storage control apparatus 200 without interposing the network such as the SAN 600. The communication between the information processing apparatuses (4) and (5) 500 and the storage control apparatus 200 may be established in accordance with a communication protocol such as FICON (Fibre Connection) (trade mark), ESCON (Enterprise System Connection) (trade mark), ACONARC (Advanced Connection Architecture) (trade mark), FIBARC (Fibre Connection Architecture) (trade mark) and the like.

Of course, the connection between the information processing apparatus 500 and the storage control apparatus 200 is not limited to the cases where they are connected via the SAN 600 and where they are directly connected without interposing the SAN, and may be performed, for example, via a local area network (LAN). In the case where they are connected via the LAN, the communication may be established, for example, in accordance with a TCP/IP protocol (transmission control protocol/internet protocol).

<Storage Drive Apparatus>

The storage drive apparatus 300 is provided with a lot of physical disk drives for storing data. Thereby, it can provide a large-capacity storage region to the information processing apparatus 500. The physical disk drive can be configured by a data storage medium such as a hard disk drive, or a plurality of hard disk drives configuring a RAID (redundant array of inexpensive disks). Further, in a physical volume that is a physical storage region provided by the physical disk drive, a logical volume that is a logical record region can be set. A storage region for storing data, including the physical volume and the logical volume is also described as a storage volume 310.

The connection between the storage control apparatus 200 and the storage drive apparatus 300 may be in the form of direct connection as shown in FIG. 1, or may be performed via the network. Further, the storage drive apparatus 300 may be configured integrally with the storage control apparatus 200.

<Storage Control Apparatus>

The storage control apparatus 200 is provided with a channel control unit 210, a shared memory 220, a cache memory 230, a disk control unit 240, a management terminal 250, and an internal connection unit 260. The storage control apparatus 200 establishes communication with the information processing apparatuses (1) to (3) 500 via the SAN 600 by the channel control units (1) to (5) 210. Further, the storage control apparatus 200 establishes communication with the information processing apparatus (4) 500 by the channel control units (6) and (7) 210, and establishes communication with the information processing apparatus (5) 500 by the channel control unit (8) 210.

The channel control unit 210 is provided with a communication interface for establishing the communication with the information processing apparatus 500, receives the data input/output request from the information processing apparatus 500, and executes transmission and reception of data along with the information processing apparatus 500.

The channel control units 210 are connected to one another via along with the management terminal 250 by the internal LAN. Accordingly, a micro program or the like executed by the channel control unit 210 can be sent from the management terminal 250, whereby its installation becomes possible.

The internal connection unit 260 connects the channel control unit 210, the shared memory 220, the cache memory 230, and the disk control unit 240 to one another. Exchanges of data and command among the channel control unit 210, the shared memory 220, the cache memory 230, and the disk control unit 240 are executed via the internal connection unit 260. The internal connection unit 260 is composed, for example, by a crossbar switch.

The shared memory 220 and the cache memory 230 are memories for storing the date exchanged between the channel control unit 210 and the disk control unit 240. The shared memory 220 is mainly utilized for storing control information and commands etc., whereas the cache memory 230 is mainly utilized for storing data.

For example, in the case where the data input/output request received by a certain channel control unit 210 from the information processing apparatus 500 is a data writing request, the relevant channel control unit 210 writes the data writing request in the shared memory 220 and writes the written data received from the information processing apparatus 500 in the cache memory 230. On the other hand, the disk control unit 240 monitors the shared memory 220. When detecting that the data writing request is written in the shared memory 220, the disk control unit 240 reads the written data from the cache memory 230 in accordance with the data writing request and writes it in the storage volume 310 within the storage drive apparatus 300.

Further, in the case where the data input/output request received by a certain channel control unit 210 from the information processing apparatus 500 is a date reading request, the channel control unit 210 checks whether read data to be a read subject exists in the cache memory 230. At this time, if the read data exists in the cache memory 230, the channel control unit 210 sends the read data to the information processing apparatus 500. On the other hand, in the case that the read data does not exist in the cache memory 230, the channel control unit 210 writes the data reading request in the shared memory 220 and monitors the shared memory 220. The disk control unit 240 detecting that the data reading request is written in the shared memory 220 reads read data to be a read subject from the storage volume 310 within the storage drive apparatus 300, writes the read data in the cache memory 230 and writes that effect in the shared memory 220. Further, when detecting that the read data to be a read subject is written in the cache memory 230, the channel control unit 210 sends the read date to the information processing apparatus 500.

As mentioned above, the exchange of data is executed via the memory 230 between the channel control unit 210 and the disk control unit 240, and the data, which is read and written by the channel control unit 210 and the disk control unit 240 among the data stored in the storage volume 310, is stored in the cache memory 230.

The disk control unit 240 is communicably connected to a plurality of storage volumes 310 for storing data, thereby executing control of the storage drive apparatus 300. For example, as mentioned above, the disk control unit 240 reads and writes the data with respect to the storage volume 310 on the basis of the data input/output request received from the information processing apparatus 500.

Each of the disk control units 240 is connected to each other along with the management terminal 250 by the internal LAN, thereby allowing the communication with each other to be established. Accordingly, the micro program etc. executed by the disk control unit 240 can be sent from the management terminal 250, whereby its installation becomes possible.

<Management Terminal>

The management terminal 250 is an information device for maintaining and managing the storage system 100. An operator can execute: by operating the management terminal 250, for example, setting of the configuration of the physical disk drive within the storage drive apparatus 300; setting of a path that is a communication path between the information processing apparatus 500 and the channel control unit 210; setting of the storage volume; installation of the micro program executed by the channel control unit 210 and the disk control unit 240; and the like. These settings and controls can be executed by the operator etc. from a user interface with which the management terminal 250 is provided or a user interface of the information processing apparatus that displays a web page supplied from a web server actuated by the management terminal 250.

<Configuration of Channel Control Unit>

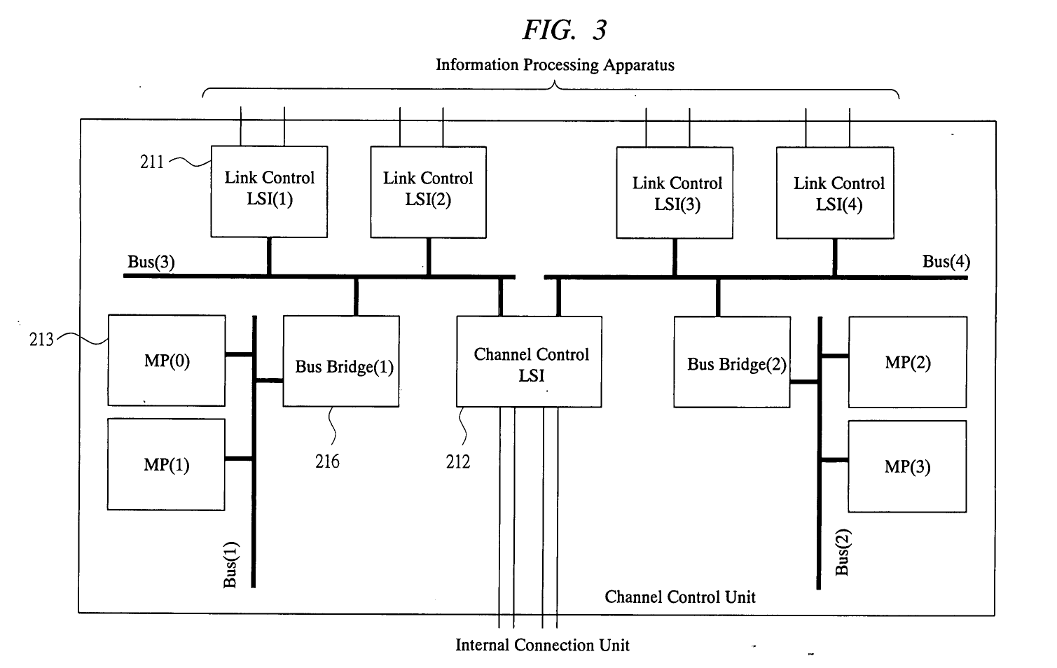

A description will be made of an example of a configuration of a channel control unit in a storage system according to an embodiment of the present invention with reference to FIGS. 2 and 3. FIG. 2 is a block diagram showing a configuration of a channel control unit of the present embodiment, and FIG. 3 is a block diagram showing a configuration of a conventional channel control unit as a comparative embodiment of FIG. 2.

A channel control unit 210 of the present embodiment is configured by: a plurality of (eight in FIG. 2) link control LSIs 211 connected to the information processing apparatus 500; a plurality of (two in FIG. 2) channel control LSIs 212 connected to the internal connection unit 260; a plurality of (eight in FIG. 2) processors (MP) 213; and the like, as shown in FIG. 2.

In the channel control unit 210, the link control LSIs (1) and (2) are connected to the channel control LSI (1) via the bus (3), and the link control LSIs (3) and (4) are connected to the channel control LSI (1) via the bus (4), respectively. Further, the processors (0) and (1) are connected to the channel control LSI (1) via the bus (1), and the processors (2) and (3) are connected to the channel control LSI (1) via the bus (2), respectively. In the same manner, the link control LSIs (5) and (6) are connected to the channel control LSI (2) via the bus (7), and the link control LSIs (7) and (8) are connected to the channel control LSI (2) via the bus (8), respectively. Further, the processors (4) and (5) are connected to the channel control LSI (2) via the bus (5), and the processors (6) and (7) are connected to the channel control LSI (2) via the bus (6), respectively.

The link control LSI 211 provides a communication interface function for establishing communication with the information processing apparatus 500, receives a data input/output request command from the information processing apparatus 500, and establishes communication with the processor 213. Further, the transmission and reception of data are executed with respect to the information processing apparatus 500 by establishing communication with the channel control LSI 212.

The channel control LSI 212 has therein a DMA (direct memory access: data transfer control unit) and a function of a bus bridge, whereby data is transferred between the cache memory 230 and the link control LSI 211 on the basis of an instruction of the processor 213.

The processor 213 executes: a process of a command of the data input/output request from the information processing apparatus 500; management of the cache memory 230; and control of the channel control LSI 212.

On the contrary, the conventional channel control unit has a configuration of: a plurality of (four in FIG. 3) link control LSIs 211 connected to the information processing apparatus 500; a channel control LSI 212 connected to the internal connection unit 260; a plurality of (four in FIG. 3) processors (MPs) 213; and a plurality of (two in FIG. 3) bus bridges 216, as shown in FIG. 3.

However, in the storage system 100, the number of channels connected to the information processing apparatus 500 becomes an important factor for constructing various information processing systems, and the number goes on increasing. In response to the demand and in order to increase the number of channels under the condition that the conventional configuration (FIG. 3) remains unchanged, it is necessary to increase the link control LSI 211 and also increase the processors 213, the channel control LSI 212, and further the bus bridge 216 for processing the link control unit LSI having been increased. Thus, in order to arrange the plurality of LSIs and the plurality of buses on the package, problems of an area of arrangement, a bus speed, and the like arise.

Accordingly, in the present embodiment, more channels can be mounted on the package by making the channel control LSI 212 shown in FIG. 2 have a bus bridge function and reducing the number of LSIs required per one channel. The internal structure of the channel control LSI 212 will be later described.

<Operation of Channel Control Unit>

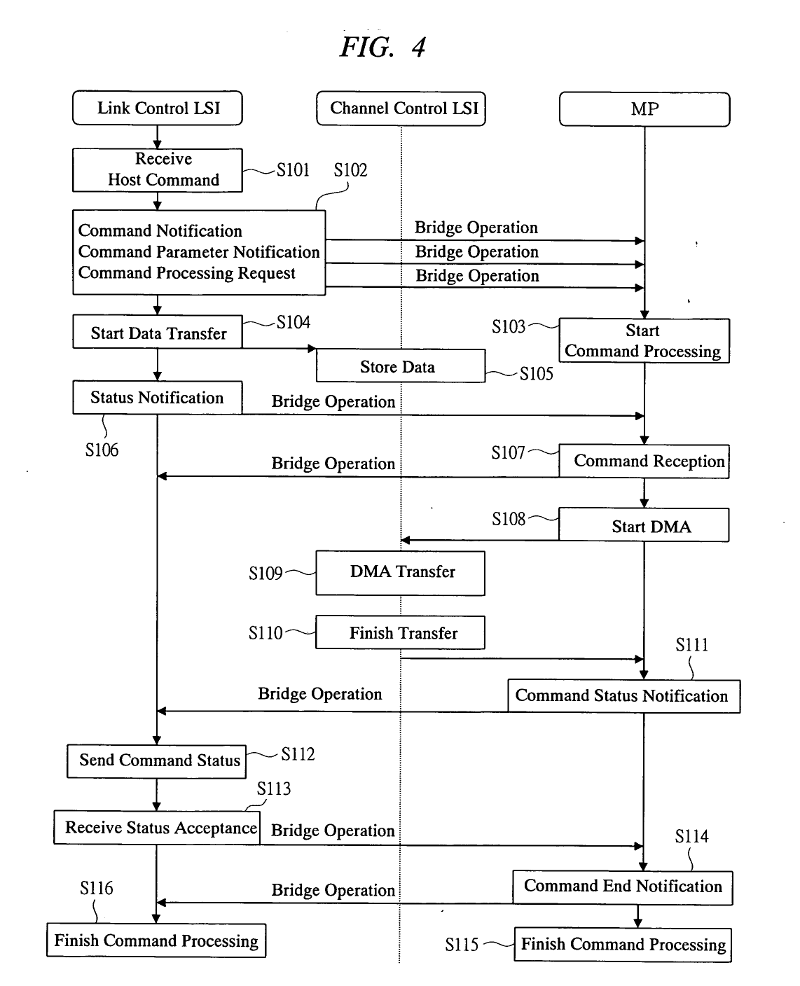

A description will be made of an example of an operation (data writing operation) of a channel control unit with reference to FIG. 4. FIG. 4 is a flow chart showing an operation of a channel control unit.

First, when receiving a data input request (host command) from the information processing apparatus 500 (S101), the link control LSI 211 makes requests for a command notification, a command parameter notification, and a command processing to the processor (MP) 213 via a bridge operation of the channel control LSI 212 (S102). Further, the processor 213 starts the command processing (S103).

Further, the link control LSI 211 stores the data received from the information processing apparatus 500, in the channel control LSI 212 (S104 and S105).

Subsequently, the link control LSI 211 gives a status notification to the processor 213 via the bridge operation of the channel control LSI 212 (S106). Further, the processor 213 makes a response of a reception command to the link control LSI 211 via the bridge operation of the channel control LSI 212 (S107).

Further, the processor 213 starts the DMA (S108). Further, the channel control LSI 212 executes DMA transfer (S109) and stores the data, which is stored in the channel control LSI 212 (S105), in the cache memory 230. When the DMA transfer is finished, the channel control LSI 212 reports it to the processor 213 (S110).

Subsequently, the processor 213 makes a notification of a command status to the link control LSI 211 via the bridge operation of the channel control LSI 212 (Sill). Additionally, the link control LSI 211 transmits the command status to the information processing apparatus 500 (S112).

Further, when receiving status acceptance from the information processing apparatus 500, the link control LSI 211 reports on it to the processor 213 via the bridge operation of the channel control LSI 212 (S113). The processor 213 makes a command end notification to the link control LSI 211 via the bridge operation of the channel control LSI 212 (S114).

Accordingly, the command processing in the processor 213 is finished (S115) and the command processing in the link control LSI 211 is also finished (S116).

<Configuration of Channel Control LSI>

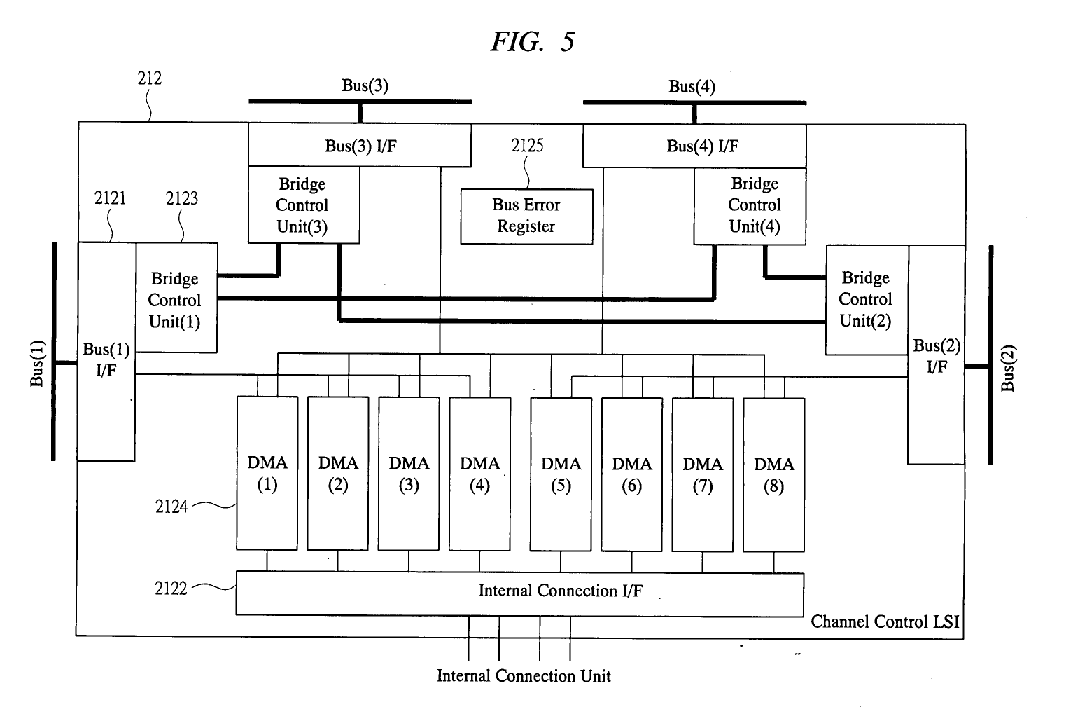

A description will be made of a configuration of a channel control LSI with reference to FIG. 5. FIG. 5 is a block diagram showing a configuration of the channel control LSI.

The channel control LSI 212 is, as shown in FIG. 5, connected to the external unit through exclusive bus I/F (1) to (4) 2121 connected to four external buses (1) to (4) and through an exclusive internal connection I/F 2122 connected to the internal connection unit 260. Bridge control units (1) to (4) 2123 serving as a bus bridge control means inside the LSI is connected between the buses (1) and (3), (1) and (4), (2) and (3), and (2) and (4), respectively.

DMA (1) to (8) 2124 are installed in the channel control LSI 212, wherein there are the DMA (1) to (4) which can be controlled by the processor 213 on the bus (1) and the DMA (5) to (8) which can be controlled by the processor 213 on the bus (2) and the data is transferred along with the cache memory 230 via the link control LSI 211 and an internal connection unit 260 on the buses (3) and (4) in accordance with the instruction of the processor 213.

Also, a bus error register 2125 expressing a state of each bus and serving as a bus state storing means exists inside the channel control LSI 212, and the state of each bus can be monitored by referring to the bus error register 2125 by the processor 213.

The bus commands outputted by the processor 213 or link control LSI 211 are classified into a bridge control unit 2123, a DMA 2124 and other LSI internal register (bus error register etc.), by the bus I/F 2121 in accordance with command addresses thereof. In the case of the bridge control unit 2123, a destination to be bridged is determined further by the some command address.

In the configuration of the conventional channel control unit (FIG. 3), since the processor 213 on the bus (1) can communicate only with the link control LSI 211 on the bus (3), the processor 213 capable of the command processing is limited to the processor 213 on the bus (1) even in the case where a load of the link control LSI 211 on the bus (3) is increased. Further, in the case where failure occurs in the bus (1), the processor 213 for processing the link control LSI 211 on the bus (3) is lost, so that it is impossible to process the data input/output request asked by the information processing apparatus 500 connected to the same link control LSI 211.

In a configuration in accordance with the present embodiment, as shown in FIG. 5, by making it possible to bridge the buses n to n (two to two in FIG. 5), it becomes possible to execute such a conventionally impossible process that the data input/output request received by the link control LSI 211 on the bus (3) is processed by any one of the processors 213 on the buses (1) and (2). Therefore, a degree of freedom of each channel operation is increased and it is possible to execute control such as load sharing. Note that, in the same manner, the data input/output request received by the link control LSI 211 on the bus (4) can be processed by any one of the processors 213 on the buses (1) and (2).

<Configuration of Bridge Control Unit>

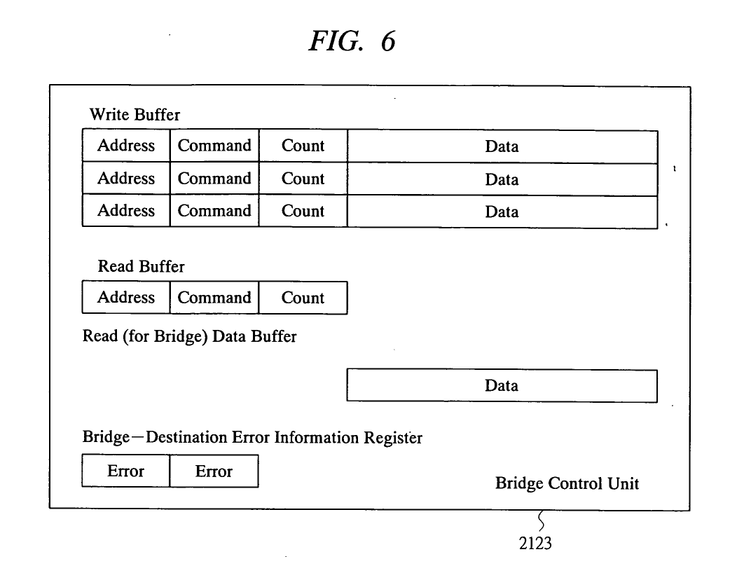

A description will be made of an example of a configuration of a bridge control unit. FIG. 6 is an explanatory diagram for showing a configuration of a bridge control unit.

The bridge control unit 2123 has, as shown in FIG. 6, three write buffers and a read buffer, which serve as address storing means in order to bridge the write bus command and the data. The three write buffers store the address, command, count, and data, and the read buffer stores the address, the command, and the count. Further, there exists a read data buffer (for bridging) for storing the read data executed at a bridge destination in the case where a request of the read bus command is outputted from the bridge control unit at a connection destination. Additionally, the bridge control unit 2123 has a bridge-destination error-information register showing a state of the bridge control unit at the connection destination.

<Connection Signal between Bridge Control Units>

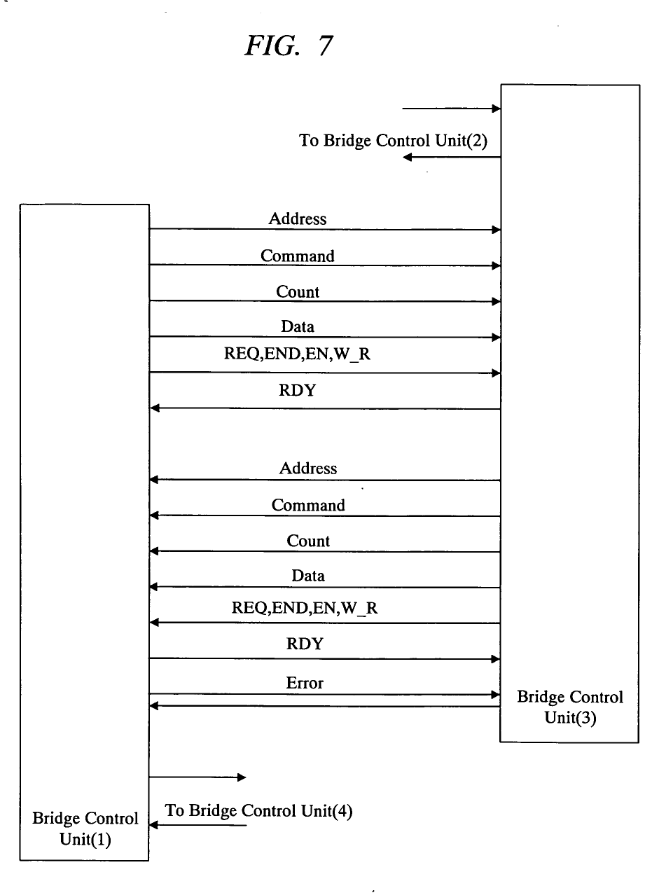

A description will be made of an example of a connection signal between the bridge control units. FIG. 7 is an explanatory diagram showing the connection signal between the bridge control units.

For example, by way of an example of a connection signal between the bridge control unit (1) 2123 and the bridge control unit (3) 2123, as shown in FIG. 7, respective signals of address, command, count, data, request (REQ), end (END), enable (EN), write-read (W-R), and ready (RDY) are sent to the bridge control unit (3) from the bridge control unit (1).

Further, in the same manner, respective signals of address, command, count, data, request, end, enable, write-read, and ready are sent to the bridge control unit (1) from the bridge control unit (3).

Further, a signal of error is also sent and received between the bridge control unit (1) and the bridge control unit (3).

Note that the same transmission is executed between the bridge control units (1) 2123 and (4) 2123, between the bridge control units (3) 2123 and (2) 2123, and further between the bridge control units (2) 2123 and (4) 2123.

<Write Bridge Operation>

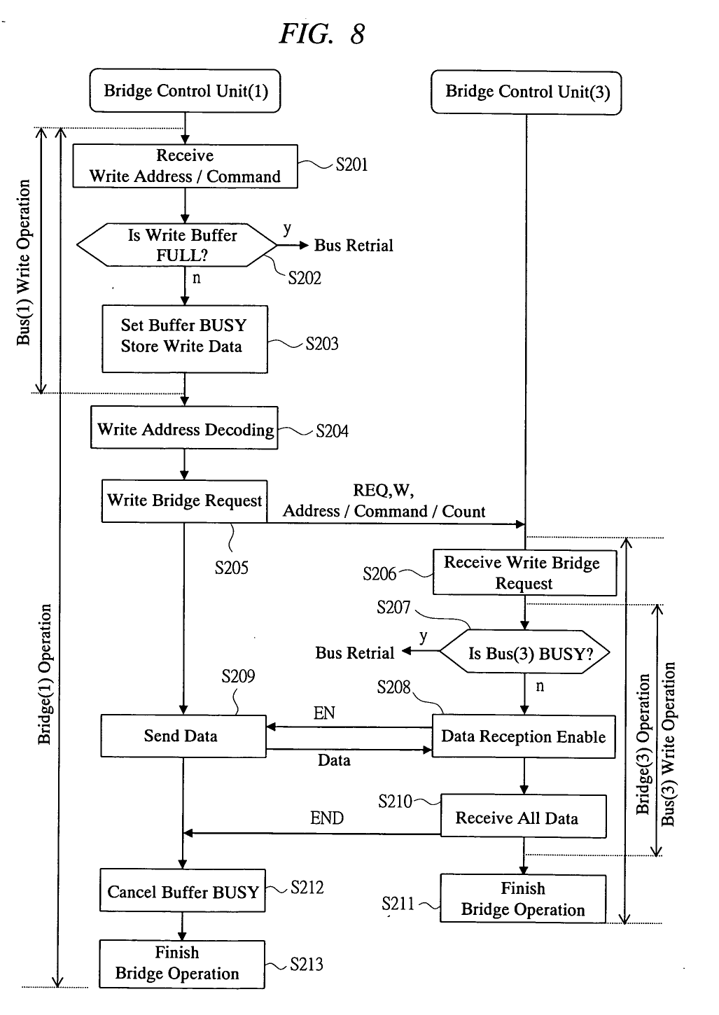

A description will be made of an example of a write bridge operation with reference to FIG. 8. FIG. 8 is a flow chart showing a write bridge operation.

In an example of operations of the bridge control units (1) 2123 and (3) 2123 in the case where a write operation is performed to the link control LSI 211 on the bus (3) from the processor 213 on the bus (1), as shown in FIG. 8, when receiving a write address/command (S201), the bridge control unit (1) determines whether the write buffer is FULL (S202). As a result of this determination, if it is FULL (y), a bus retrial is executed. If it is not FULL (n), the buffer is set to BUSY and the write data is stored (S203).

Subsequently, the bridge control unit (1) decodes the write address (S204), and makes a write bridge request to the bridge control unit (3). At this time, the respective signals of request, write address, command, and count are transmitted (S205). Further, the bridge control unit (3) receives the write bridge request (S206), and determines whether the bus (3) is BUSY (S207). As a result of the determination, if it is BUSY (y), a bus retrial is executed. If it is not BUSY (n), the data reception is made to be in an enable state (S208) and an enable signal is transmitted to the bridge control unit (1). Further, the bridge control unit (1) sends the data to the bridge control unit (3) (S209).

Further, when receiving all the data, the bridge control unit (3) sends an end signal to the bridge control unit (1) (S210), whereby the bridge operation is finished (S211). Further, the bridge control unit (1) executes a cancel of the buffer BUSY (S212), whereby the bridge operation is finished (S213).

In the above-mentioned write bridge operation, the bridge control unit (1) performs: a bus (1) write operation from receiving of the write address/command to storing of the write data; and a bridge (1) operation from receiving of the write address/command to finishing of the bridge operation. Further, the bridge control unit (3) performs: a bus (3) write operation from BUSY? of bus (3) to receiving of all the data; and a bridge (3) operation from receiving of the write bridge request to finishing of the bridge operation.

<Read Bridge Operation>

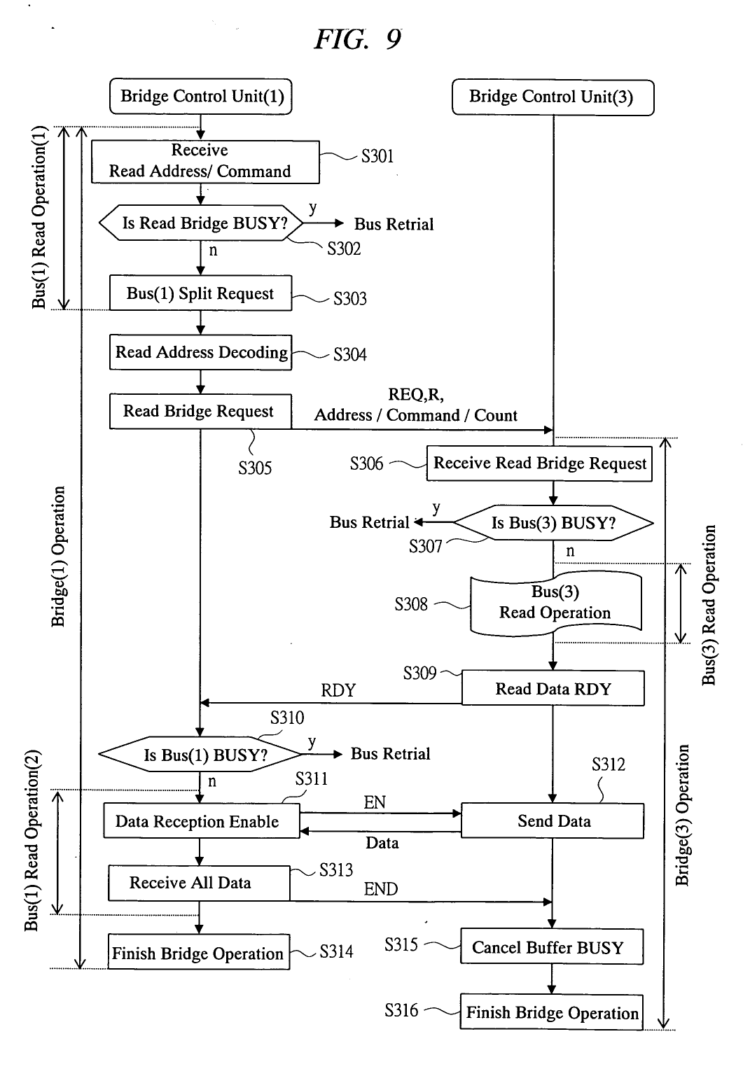

A description will be made of an example of a read bridge operation with reference to FIG. 9. FIG. 9 is a flow chart showing a read bridge operation.

In an example of operations of bridge control units (1) 2123 and (3) 2123 in the case where a read operation is performed to the link control LSI 211 on the bus (3) from the processor 213 on the bus (1), when receiving a read address/command (S301), the bridge control unit (1) determines whether the read bridge is BUSY (S302), as shown in FIG. 9. As a result of this determination, if it is BUSY (y), a bus retrial is executed. If it is not BUSY (n), a Split request of the bus (1) is made (S303).

Subsequently, the bridge control unit (1) decodes a read address (S304) and makes a read bridge request to the bridge control unit (3). At this time, respective signals of request, read address, command, and count are transmitted (S305). Further, the bridge control unit (3) receives the read bridge request (S306) and determines whether the bus (3) is BUSY (S307). As a result of the determination, if it is BUSY (y), a bus retrial is executed. If it is not BUSY (n), the read operation by the bus (3) is performed (S308) and the read data is set to a ready state and the ready signal is transmitted to the bridge control unit (1) (S309).

Further, the bridge control unit (1) determines whether the bus (1) is BUSY (S310). As a result of this determination, if it is BUSY (y), a bus retrial is executed. If it is not BUSY (n), the data reception is set to the enable state (S311) and the enable signal is transmitted to the bridge control unit (2). Further, the bridge control unit (3) sends the data to the bridge control unit (1) (S312).

Further, when receiving all the data, the bridge control unit (1) sends the end signal to the bridge control unit (3) (S313), whereby the bridge operation is finished (S314). Additionally, the bridge control unit (3) executes a BUSY cancel of the buffer (S315), whereby the bridge operation is finished (S316).

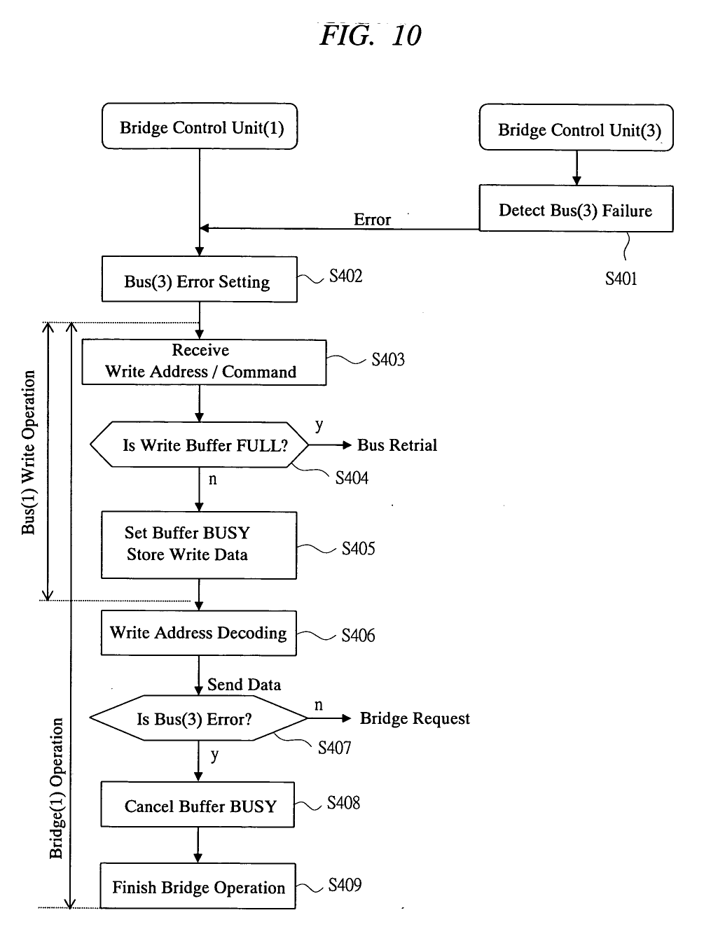

In the above-mentioned read bridge operation, the bridge control unit (1) performs: a bus (1) read operation (1) from receiving of the read address/command to the Split request of bus (1); a bus (1) read operation (2) from the data reception enable to receiving of all the data; and a bridge (1) operation from receiving of the read address/command to finishing of the bridge operation. Also, the bridge control unit (3) performs: a bus (3) read operation that is the bus (3) read operation (S308); and a bridge (3) operation from receiving of the read bridge request to finishing of the bridge operation. <Write Bridge Operation (Bus (3) Failure Case (1))>A description will be made of an example of a write bridge operation (bus (3) failure case (1)) with respect to FIG. 10. FIG. 10 is a flow chart showing a write bridge operation (bus (3) failure case (1)).

In an example of operations of the bridge control units (1) 2123 and (3) 2123 in the case where the write operation is performed to the link control LSI 211 on the bus (3) under being out of order from the processor 213 on the bus (1), when the write address is decoded, the bridge control unit (1) recognizes that a bridge destination is in an error state by referring to bridge-destination error information within the bridge control unit and then concludes without exchanging with the bridge control unit (3).

In other words, as shown in FIG. 10, when detecting failure of the bus (3), the bridge control unit (3) sends the error signal to the bridge control unit (1) (S401). Further, the bridge control unit (1) executes error setting of the bus (3) (S402).

Thereafter, in the bridge control unit (1), in the same manner as the above-mentioned write bridge operation (FIG. 8), there are executed respective operations of write address/command reception (S403), write buffer FULL? (S404), buffer BUSY setting, and write data storing (S405).

Further, the bridge control unit (1) decodes the write address (S406), and determines whether the bus (3) is in an error state (S407). As a result of this determination, if it is not in the error state (n), the bridge request is made. If it is in the error state (y), a BUSY cancel of the buffer is executed (S408), whereby the bridge operation is finished (S409).

<Write Bridge Operation (Bus (3) Failure Case (2))>

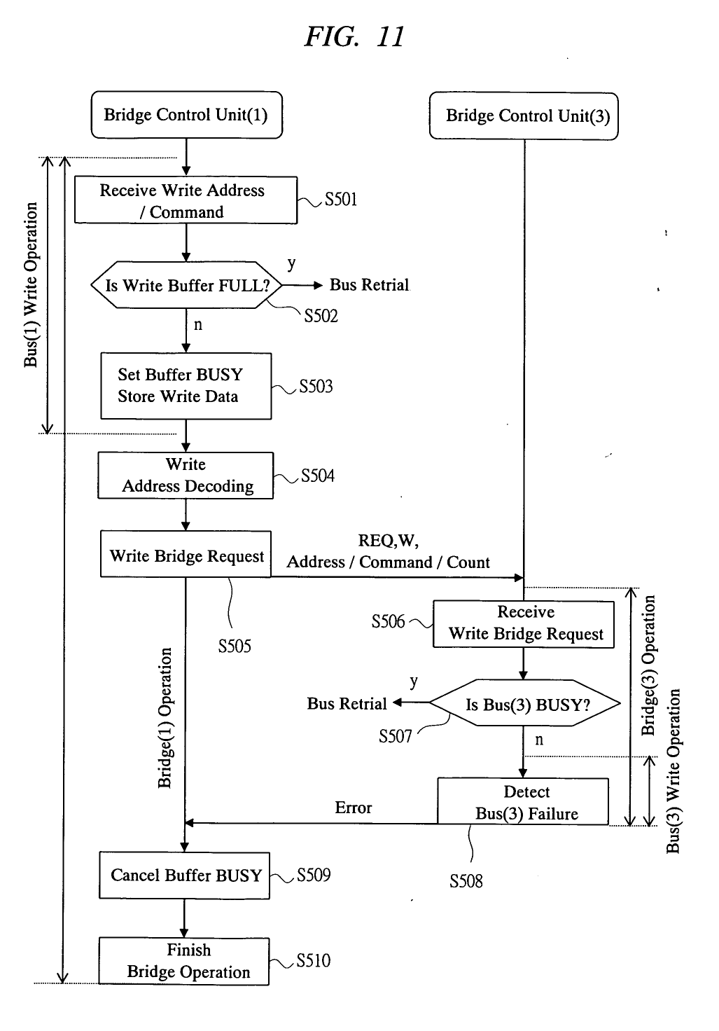

A description will be made of an example of a write bridge operation (bus (3) failure case (2)) with respect to FIG. 11. FIG. 11 is a flow chart showing a write bridge operation (bus (3) failure case (2)).

The flow chart in FIG. 11 is different from that in FIG. 10 as mentioned above in the point that the failure is detected at a stage in which the bus (3) actually operates.

In other words, as shown in FIG. 11, in the bridge control units (1) 2123 and (3) 2123, in the same manner as the above-mentioned write bridge operation (FIG. 8), there are executed respective operations of write address/command reception (S501), write buffer FULL? (S502), buffer BUSY setting, write data storing (S503), write address decoding (S504), write bridge request (S505), write bridge request reception (S506), and bus (3) BUSY? (S507).

Further, when detecting the failure of the bus (3), the bridge control unit (3) sends the error signal to the bridge control unit (1) (S508). Further, the bridge control unit (1) executes a BUSY cancel of the buffer (S509), whereby the bridge operation is finished (S510).

In both of the operations in FIG. 11 and FIG. 10, the bridge control unit (1) 2123 recognizes the failure of the bus (3), and the bridge operation between the buses (1) and (4) is not affected based on the failure of the bus (3) by releasing the write buffer within the bridge control unit (1) and finishing the bus (1) and (3) bridge operations.

Further, in this operation, the processor 213 does not know whether the write operation is correctly applied to the link control LSI 211 on the bus (3). However, the command processing in the channel control unit 210 is executed while an interlock between the link control LSI 211 and the processor 213 is ensured, as shown in FIG. 5. Therefore, the failure of the bus (3) can detected by referring to the bus error register 2125 of the channel control LSI 212 on the basis of the fact that no response is outputted from an opponent, in the case where the bus (3) is out of order as in these flows.

<Read Bridge Operation (Bus (3) Failure Case (1))>

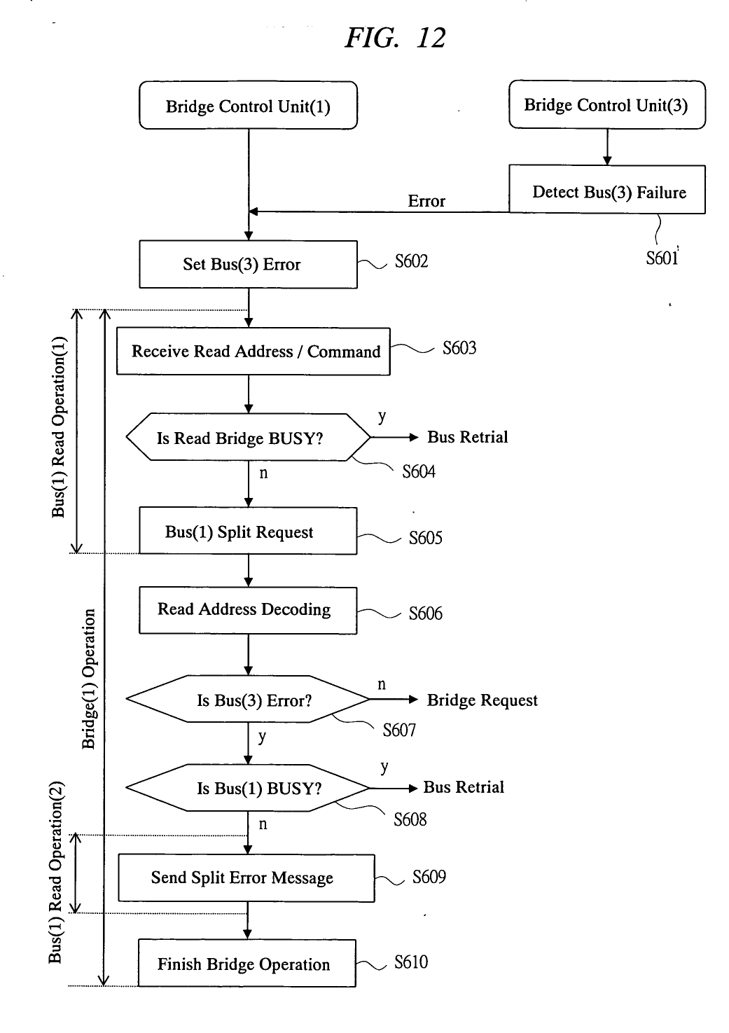

A description will be made of an example of a read bridge operation (bus (3) failure case (1)) with reference to FIG. 12. FIG. 12 is a flow chart showing a read bridge operation (bus (3) failure case (1)).

In an example of the operations of the bridge control units (1) 2123 and (3) 2123 in the case where the read operation is performed to the link control LSI 211 on the faulty bus (3) from the processor 213 on the bus (1), when decoding the read address, the bridge control unit (1) recognizes that a destination to be bridged is in an error state by referring to the bridge-destination error information within the bridge control unit, and changes the error message in place of the read data in response to the read request of the processor without exchanging with the bridge control unit (3).

In other words, as shown in FIG. 12, when detecting the failure of the bus (3), the bridge control unit (3) sends the error signal to the bridge control unit (1) (S601). Further, the bridge control unit (1) executes the error setting of the bus (3) (S602).

Thereafter, in the same manner as the above-mentioned, read bridge operation (FIG. 9), the bridge control unit (1) performs respective operations of read address/command reception (S603), read bridge BUSY? (S604), bus (1) Split (S605), and read address decode (S606).

Further, the bridge control unit (1) determines whether the bus (3) is in an error state (S607). As a result of this determination, if it is not in the error state (n), the bridge request is executed. If it is in the error state (y), the bridge control unit (1) determines whether the bus (1) is BUSY (S608). As a result of this determination, if it is BUSY (y), a bus retrial is executed. If it is not BUSY (n), the Split error message is sent (S609), whereby the bridge operation is finished (S610).

<Read Bridge Operation (Bus (3) Failure Case (2))>

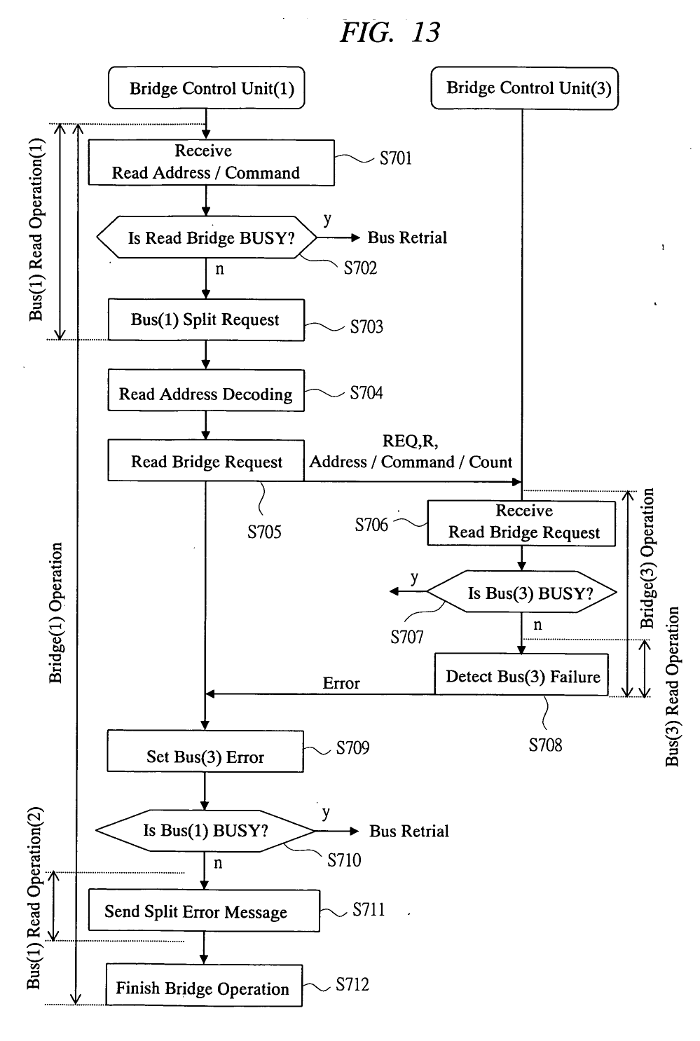

A description will be made of an example of a read bridge operation (bus (3) failure case (2)) with reference to FIG. 13. FIG. 13 is a flow chart showing a read bridge operation (bus (3) failure case (2)).

The operations in FIG. 13 are different from those in FIG. 12 mentioned above in the point that the failure is detected at a stage where the bus (3) actually operates.

In other words, as shown in FIG. 13, in the bridge control units (1) 2123 and (3) 2123, in the same manner as the above-mentioned read bridge operation (FIG. 9), there are executed respective operations of read address/command reception (S701), read bridge BUSY? (S702), bus (1) Split (S703), read address decode (S704), read bridge request (S705), read bridge request reception (S706), and bus (3) BUSY? (S707).

Further, when detecting the failure of the bus (3), the bridge control unit (3) sends the error signal to the bridge control unit (1) (S708). Further, the bridge control unit (1) executes the error setting of the bus (3) (S709), and determines whether the bus (1) is BUSY (S710). As a result of this determination, if it is BUSY (y), the bus retrial is executed. If it is not BUSY (n), the Split error message (S711) is sent, whereby the bridge operation is finished (S712).

In both of the operations in FIG. 13 and FIG. 12, the bridge control unit (1) 2123 recognizes the failure of the bus (3), and the bridge operation between the buses (1) and (4) is not affected based on the failure of the bus (3) by returning the error message to the bus (1) and finishing the bus (1) and (3) bridge operations.

<Bridge Path at Bus (3) Failure>

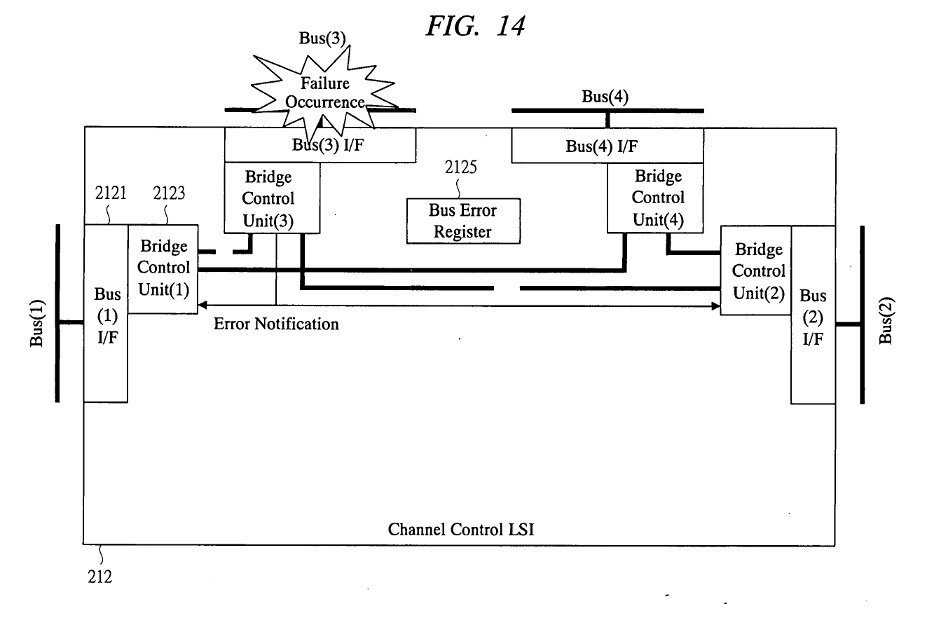

A description will be made of an example of a bridge path at a time of, bus (3) failure. FIG. 14 is an explanatory diagram for showing a bridge path at a time of the bus (3) failure.

In an example of the bridge path at the time of the bus (3) failure, as shown in FIG. 14, the failure occurs in the bus (3), and the bridge control unit (3) 2123 detecting the failure notifies the bridge control units (1) and (2) 2123 of the error, whereby the bridge control units (1) and (2) give up the bridge operation to the bus (3).

At this time, the respective bridge operations between the buses (1) and (4) and between the buses (2) and (4) are executed with no problem.

<Bridge-Destination Space MAP of Bus (3)>

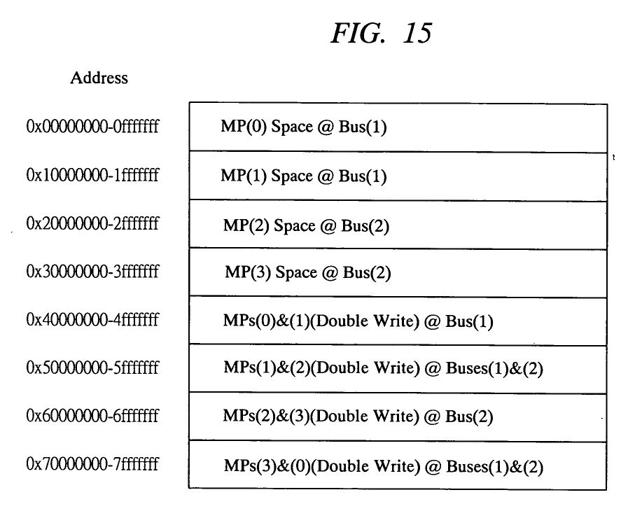

A description will be made of an example of a bridge-destination space MAP of the bus (3) with reference to FIG. 15. FIG. 15 is an explanatory diagram for showing a bridge-destination space MAP of the bus (3).

In an example of a bridge-destination space MAP of the bus (3), as shown in FIG. 15, a bridge destination is allocated to each of the addresses, and the bridge control unit (3) 2123 decodes the allocated address and determines its bridge destination.

For example, if an address 0x00000000 is accessed, the accessing is an operation of the bridge to the bus (1), so that a request is made to the bridge control unit (1) 2123. If an address 0x30000000 is accessed, the accessing is an operation of the bridge to the bus (2), so that a request is made to the bridge control unit (2) 2123. Further, if an address 0x50000000 is accessed, the accessing is an operation of the double write, so that requests are made to the bridge control units (1) 2123 and (2) 2123. Note that the operation of the double write will be described later.

<Double Write Bridge Operation>

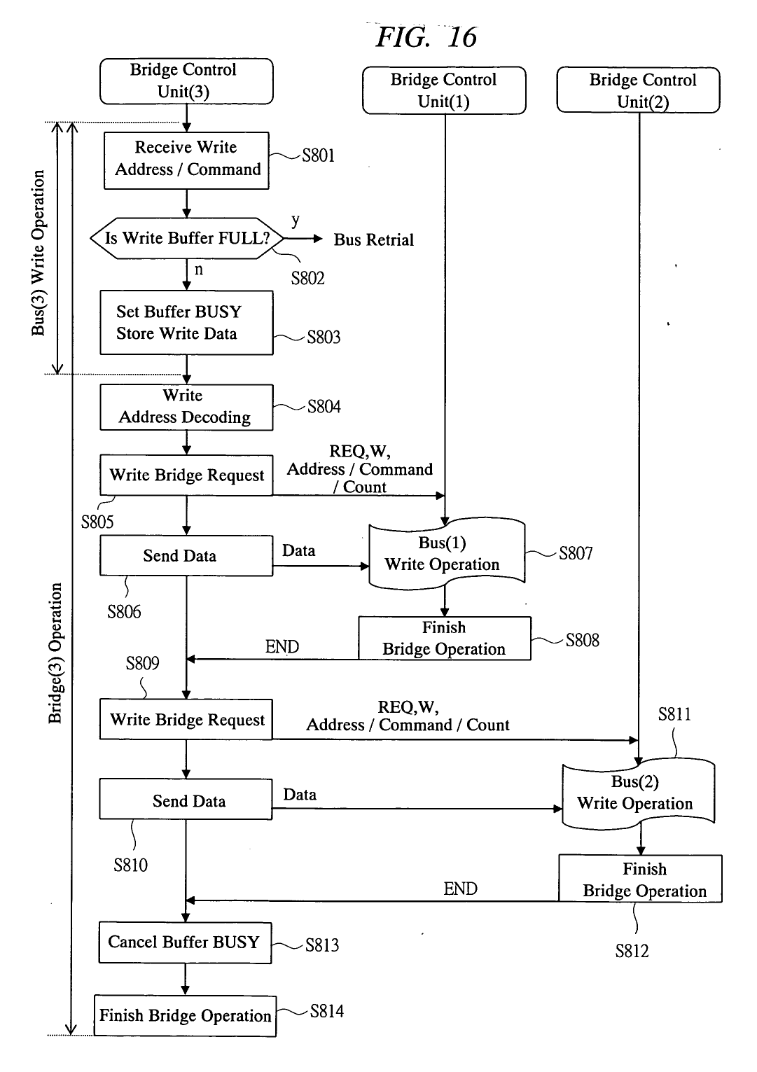

A description will be made of an example of a double write bridge operation with reference to FIG. 16. FIG. 16, is a flow chart showing a double write bridge operation.

In an example of operations of the bridge control unit (3) 2123 and the bridge control units (1) and (2) 2123 in the case that the write operation is performed to the processors 213 on the buses (1) and (2) from the link control LSI 211 on the bus (3), the same operation as the above-mentioned write bridge operation (FIG. 8) is performed to the bridge control units (1) 2123 and (2) 2123.

In other words, as shown in FIG. 16, the bridge control unit (3) performs respective operations of write address/command reception (S801), write buffer FULL? (S802), buffer BUSY setting, write data storing (S803), and write address decoding (S804).

Further, the bridge control unit (3) first makes a write bridge request to the bridge control unit (3) (S805), and sends data to the bridge control unit (1) (S806). Further, the bridge control unit (1) executes the bus (1) write operation (S807) and, after the bridge operation is finished, sends the end signal to the bridge control unit (3) (S808).

In the same manner, the bridge control unit (3) makes a write bridge request to the bridge control unit (2) (S809) and sends data to the bridge control unit (2) (S810). Further, the bridge control unit (2) executes the bus (2) write operation (S811) and, after the bridge operation is finished, sends the end signal to the bridge control unit (3) (S812).

Further, the bridge control unit (3) executes a BUSY cancel of the buffer (S813), whereby the bridge operation is finished (S814).

<Command-Processing Request Method using Double Write>

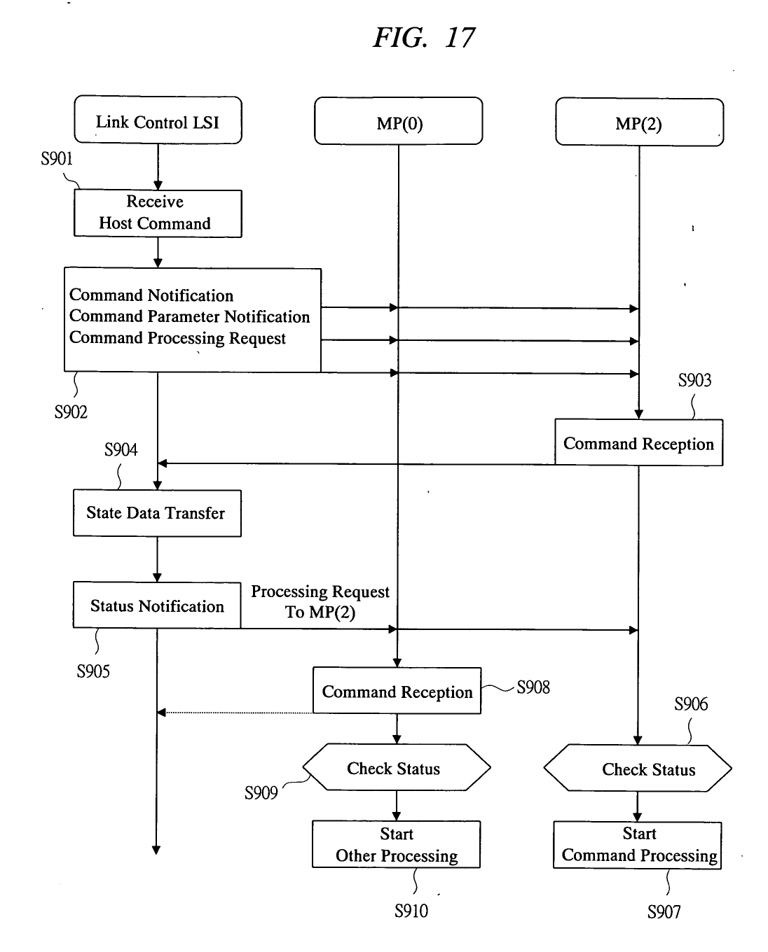

A description will be made of an example of a command-processing request method using a double write with reference to FIG. 17. FIG. 17 is a flow chart showing a command-processing request method using a double write.

In the command-processing request method using the double write, the same operation as the operation (FIG. 4) of the above-mentioned channel control unit 210 is operated to two processors 213.

In other words, as shown in FIG. 17, when receiving a host command (S901), the link control LSI 211 performs respective operations of a command notification, a command parameter notification, a command-processing request to a double written area (S902), and the processor (MPs (0) and (2) in this example) 213 notified of the command sends a response of the command reception-to the link control LSI 211 at a time of catching up the command (S903).

Further, by the link control LSI 211, the processor (MP (2) in this example) 213 responding to the command reception is made to process the command generally in first-respond order. At this time, the link control LSI 211 starts transferring the data to the channel control LSI 212 (S904), and notifies the double written area of a status including the fact that the processor (MP (2)) 213 is selected (S905), whereby the processor (MP (2)) 213 starts, after a status check (S906), the command processing formerly (S907). On the other hand, the processor (MP (0)) 213 late responding to the command receipt (S908) can starts, after the status check (S909), other processing (S910).

<Configuration of Other Channel Control Unit>

A description will be made of an example of a configuration of other channel control unit according to the present embodiment with reference to FIG. 18. FIG. 18 is a block diagram showing a configuration of other channel control unit.

A configuration of the other channel control unit 210a is different from that in FIG. 2 in the point that two channel control LSIs (1) and (2) are connected by the bus (2) therebetween and further the bus (2) is provided with a path management information memory 214, as shown in FIG. 18. Since other elements such as the link control LSI 211, the channel control LSI 212, and the processor (MP) 213 have the same structures and functions as those in FIG. 2, the description thereof will be omitted.

The path management information memory 214 can be accessed from the management terminal 250 and the link control LSI 211, wherein path connectability information is set by the management terminal 250 and the link control LSI 211 refers to the path management information memory 214 and executes path establishment control. Further, the link control LSI 211 records path establishment information etc. and connection state information, whereby the path state can be referred by the management terminal 250.

<Configuration of Path Management Information Memory>

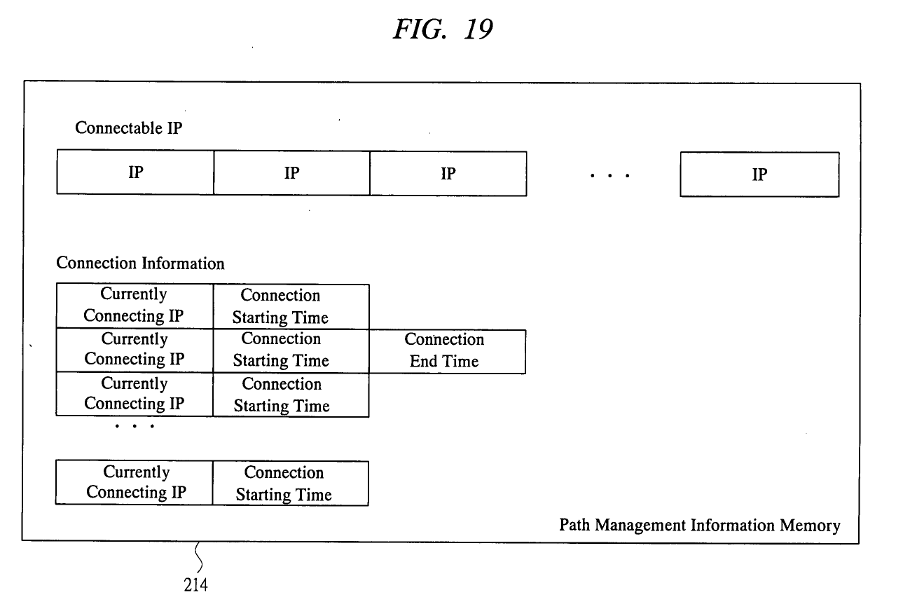

A description will be made of an example of a configuration of a path management information memory with reference to FIG. 19. FIG. 19 is an explanatory diagram for showing a configuration of a path management information memory.

In a path management information memory 214, as shown in FIG. 19, there are stored connection information including a connectable IP, a connecting IP, a connection starting time, and a connection end time, and the like. In order to determine whether the path can be established, “IP” is shown as information for identifying opponents. This may be shown by WWN etc. of fiber channel as far as the opponents can be identified. Further, by recording the currently connecting IP and a connecting time thereof as the connection information, a path condition of each channel can be comprehended by the management terminal 250.

<Path Establishing Procedure>

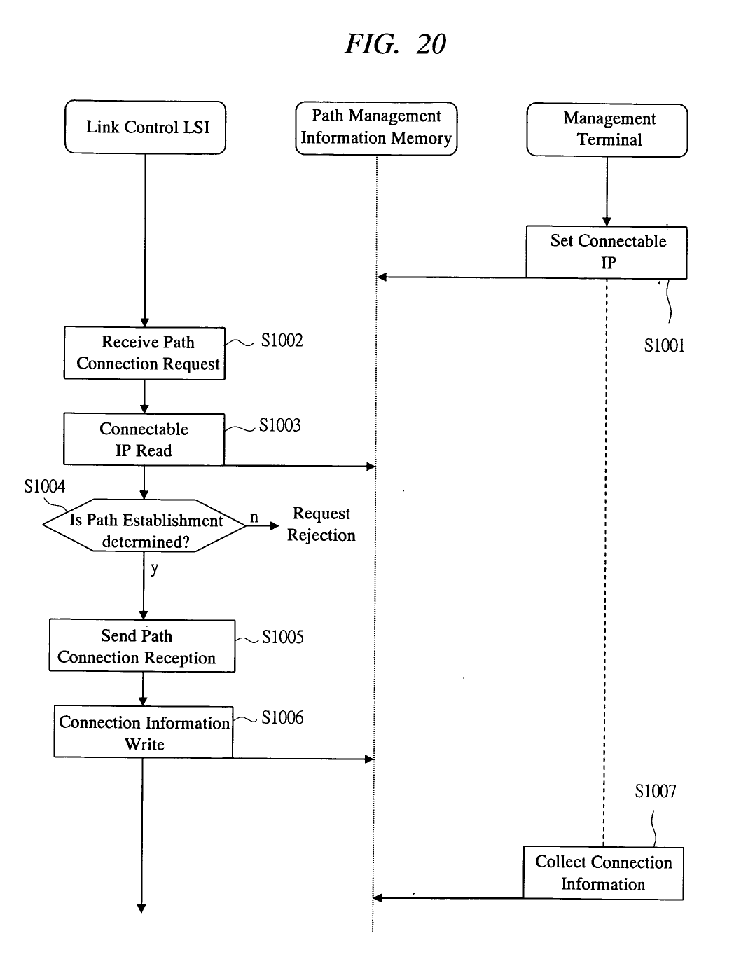

A description will be made of an example of a path establishing procedure. FIG. 20 is a flow chart showing a path establishing procedure.

In the case where the link control LSI 211 establishes paths by using the path management information memory 214, the management terminal 250 first sets the connectable IP, into the path management information memory 214 (S1001). Further, when receiving a bus connection request (S1002), the link control LSI 211 reads the connectable IP from the path management information memory 214 (S1003) and determines whether the paths are established (S1004). As a result of this determination, if the path establishment is impossible (n), the request is refused. If the path establishment is possible (y), the path connection reception is transmitted (S1005). Further, the link control LSI 211 writes the connection information in the path management information memory 214 (S1006). Then, the management terminal 250 collects the connection information from the path management information memory 214 (S1007).

<Effects of Present Embodiment>

(i) Since the channel control LSI 212 is made to have a bus bridge control function and the number of LSIs required per one channel is reduced by installing the bridge control unit 2123 into the channel control LSI 212, it is possible to mount more channels on a package, for example, connect a plurality of link control LSIs 211 and processors 213.

That is, in the channel control unit having the conventional configuration, the link control, the channel control, and the bus bridge have been respectively arranged in independent LSIS. However, in order to increase the number of channels and increase a degree of freedom of the system configuration, it is necessary to arrange a plurality of LSIs or buses on the package, so that the area of arrangement, the bus speed, and the like have occurred as problems. Therefore, the present embodiment can solve the problems.

(ii) It is possible to access the processor 213 on the bus (1) and the link control LSIs 211 on the buses (3) and (4) by making it possible to bridge a plurality of sets of bridge control units 2123 installed into the channel control LSI 212, being provided with a plurality of write buffers in the bridge control unit 2123, and changing the bridge destination by the address thereof. Therefore, the degree of freedom of the operation of each channel is increased and control such as load sharing can be executed. Further, since a plurality of connection lines are connected to the internal connection unit 260, reliability thereof can be improved.

That is, in the conventional configuration, if the load of the link control LSI on the bus (3) is increased, there is the problem that the processor capable of processing is limited to the processor on the bus (1) (because the bus (3) is not connected to the bus (2)). However, the present embodiment can solve the problem.

(iii) When the bridge control unit 2123 installed in the channel control LSI 212 monitors the bus state of the connection destination and the bridge request is set to the fault bus, the bridge operation is swept. If the bridge destination is other bus, its operation is normally bridged and thereby other bridge operations can be continued without being affected by the failure etc. of the bridge destination.

Namely, in the conventional configuration, the failure is propagated to the other buses depending on the failure of the bus (3). Even if the failure occurs in the bus (3), the access to the failure bus occurs because a time lag exists until the access is stopped by detecting simultaneously the failures of the data existing in the buffer within the bridge and of the processor on the bus (1) or (2). In this case, there have been the problems that the data is not processed in the buffer within the bridge, the retrial time out is generated on the bus (1) or (2), and the like. However, the present embodiment can solve the problems.

(iv) The write command issued by the link control LSI 211 on the bus (3) is made to communicate with the two processors 213 on the buses (1) and (2) by providing the double write function to the bridge control unit 2123 of the channel control LSI 212, and the host command is more effectively processed by making a processing request to the quickly responding processor among the processors that receives the command and can process it. Therefore, it is possible to selectively determine the processor which is made to process the host command by the link control LSI 211, on the basis of the less communication number.

That is, in the conventional configuration, when the selectable processor is selected in sequential order in the case of making a request for processing the host command to the processor in the link control LSI, there is a possibility that the vacant processor and the busy processor are generated at a certain time, so that an uneven process is generated. Further, it is hard to comprehend the load condition of the processor by the link control LSI (for example, even if the processor itself stores its own load condition in the specific memory of the processor, the link control LSI necessarily performs a process for reading and comparing the memory in each processor). Accordingly, there is the problem on the basis of what standard the processor is selected. However, the present invention can solve the problems.

(v) The link control LSI 211 determines the establishment of the logical path by: employing the configuration in which the path management information memory 214 is provided on the path between the two channel control LSIs 212; storing the connectability information of the path, which is conventionally placed in the shared memory 220 in the path management information memory 214 having the same configuration as the conventional one by means of the management terminal 250; and determining whether the path can be connected, by referring to path management information memory 214 through the link control LSI 211. Therefore, it is possible to lower the load of the processor 213. In particular, it is possible to prevent the processing capacity of the storage system 100 from being down, with respect to an unfair logical path establishment request.

That is, in the conventional configuration, if the information processing apparatus is connected to the storage control apparatus via the network to which the unspecified number of persons can connect, such as an internet or the like, then connection requests of a plurality of logical path (path for inputting and outputting the data) occur with respect to the storage control apparatus. Conventionally, the logical path connection request received by the link control LSI makes a processing request to the processor. The processor refers to the shared memory, and determines the connectability thereof and notifies the link control LSI of the determination, whereby the logical path establishment is achieved. However, in the case where the connection requests are outputted from the unspecified number of persons as mentioned above, the determination of the path connectability is increased in number, so that there is the problem that the processing capacity of the processor is lowered and the processing capacity of the entire system is down accordingly. However, the present embodiment can solve the problem.

As described above, the invention made by the inventor has been described specifically based on the embodiment. However, needless to say, the present invention is not limited to the above-mentioned embodiment and can be variously altered and modified without departing from the gist thereof.

What is claimed is:

1. A disk array subsystem comprising:
a plurality of storage volumes storing data;
a disk control unit controlling data input and output with respect to said plurality of storage volumes;
a channel control unit receiving a data input/output request from an external unit;
a shared memory storing control information communicated by said channel control unit and said disk control unit;
a cache memory temporarily storing date communicated between said channel control unit and said disk control unit;
an internal connection unit connected to said channel control unit, said disk control unit, said shared memory, and said cache memory; and
a management terminal connected to said channel control unit, said disk control unit, and said shared memory and managing its own disk array subsystem,
wherein said channel control unit includes:
a plurality of link control LSIs establishing communication with said external unit;
a plurality of processors processing the data input/output command from said external unit; and
a channel control LSI having a bus bridge control means for changing a plurality of buses respectively connected to said plurality of link control LSIs and said plurality of processors, connecting the bus connected to said link control LSI and the bus connected to said processor by said bus bridge control means, and transferring the data between said link control LSI and said cache memory in accordance with an instruction of said processor.

2. The disk array subsystem according to claim 1,
wherein said bus bridge control means of said channel control LSI changes a plurality of buses to a plurality of other buses or vice versa, and connects each of the buses connected to said plurality of link control LSIs and each of the buses connected to said plurality of processors.

3. The disk array subsystem according to claim 2,
wherein said bus bridge control means has an address storing means for storing a connection-destination address, whereby a connection destination is changed based on an address stored in said address storing means.

4. The disk array subsystem according to claim 1,
wherein said bus bridge control means of said channel control LSI has a monitoring function of monitoring a bus state of a connection destination, whereby, as a result of monitoring by said monitoring function, a bridge operation is swept if the bus of the connection destination is failure and the bridge operation is executed if the bus of the connection destination is normal.

5. The disk array subsystem according to claim 4,
wherein said channel control LSI has a bus state storing means for storing a state of each of the buses, and said monitoring function monitors the state of each of the buses by referring to said bus state storing means.

6. The disk array subsystem according to claim 5,
wherein said channel control LSI sends an error signal to another bus bridge control means at a time when its own bus bride control means detects failure of its own bus, and sets failure information of the its own bus to the bus state storing means of said another bus bridge control means.

7. The disk array subsystem according to claim 1,
wherein said bus bridge control means of said channel control LSI has a double write function, makes two processors respectively connected to second and third buses establish communication with the input/output command issued by the link control LSI connected to a first bus, and makes a processing request to a quickly responding processor among the processors receiving and capable of processing said input/output command.

8. A disk array subsystem comprising:
a plurality of storage volumes storing data;
a disk control unit controlling data input and output with respect to said plurality of storage volumes;
a channel control unit receiving a data input/output request from an external unit;
a shared memory storing control information communicated by said channel control unit and said disk control unit;
a cache memory temporarily storing date communicated between said channel control unit and said disk control unit;
an internal connection unit connected to said channel control unit, said disk control unit, said shared memory, and said cache memory; and
a management terminal connected to said channel control unit, said disk control unit, and said shared memory and managing its own disk array subsystem,
wherein said channel control unit includes:
a plurality of link control LSIs establishing communication with said external unit;
a plurality of processors processing the data input/output command from said external unit;
a plurality of channel control LSIs each having a bus bridge control means for changing a plurality of buses respectively connected to said plurality of link control LSIs and said plurality of processors, connecting the bus connected to said link control LSI and the bus connected to said processor by said bus bridge control means, and transferring the data between said link control LSI and said cache memory in accordance with an instruction of said processor; and
a storage means each provided on the buses connected between said plurality of channel control LSIs and storing connectability information of a path.

9. The disk array subsystem according to claim 8,
wherein said link control LSI is accessible to said storage means, and refers to said storage means to determine path connectability.

10. The disk array subsystem according to claim 9,
wherein said storage means is accessible from said management terminal, and the connectability information of the path is set from said management terminal.

11. The disk array subsystem according to claim 10,
wherein said link control LSI records connection state information of the path in said storage means, and said management terminal can refer to a connection state of said path.

12. The disk array subsystem according to claim 8,
wherein said bus bridge control means of said channel control LSI changes a plurality of buses to a plurality of other buses or vice versa, and connects each of the buses connected to said plurality of link control LSIs and each of the buses connected to said plurality of processors.

13. The disk array subsystem according to claim 12,
wherein said bus bridge control means has an address storing means for storing a connection-destination address, whereby a connection destination is changed based on an address stored in said address storing means.

14. The disk array subsystem according to claim 8,
wherein said bus bridge control means of said channel control LSI has a monitoring function of monitoring a bus state of a connection destination, whereby, as a result of monitoring by said monitoring function, a bridge operation is swept if the bus of the connection destination is failure and the bridge operation is executed if the bus of the connection destination is normal.

15. The disk array subsystem according to claim 14,
wherein said channel control LSI has a bus state storing means for storing a state of each of the buses, and said monitoring function monitors the state of each of the buses by referring to said bus state storing means.

16. The disk array subsystem according to claim 15,
wherein said channel control LSI sends an error signal to another bus bridge control means at a time when its own bus bride control means detects failure of its own bus, and sets a failure information of the its own bus to the bus state storing means of said another bus bridge control means.

17. The disk array subsystem according to claim 8,
wherein said bus bridge control means of said channel control LSI has a double write function, makes two processors respectively connected to second and third buses establish communication with the input/output command issued by the link control LSI connected to a first bus, and makes a processing request to a quickly responding processor among the processors receiving and capable of processing said input/output command.
